(19) United States
(12) Patent Application Publication
(10) Pub. No.: US 2019/0129733 A1
(43) Pub. Date: May 2, 2019

(54) ANDROID DYNAMIC FRAMEWORK AND A METHOD THEREOF

(71) Applicants: NATIONAL TAIWAN UNIVERSITY, Taipei City (TW); MEDIATEK INC, Hsinchu (TW)

(72) Inventors: Shih-Wei Liao, Taipei City (TW); Kuan-Yu Lin, Taipei City (TW); Jian-Min Liu, Taipei City (TW); Chieh-Hsun Yang, Taipei City (TW); Mai-Hsuan Chia, Taipei City (TW); Bai-Yueh Ke, Taipei City (TW); Yi-Lin Li, Taipei City (TW)

(21) Appl. No.: 15/897,153

(22) Filed: Feb. 15, 2018

(30) Foreign Application Priority Data
Oct. 30, 2017 (TW) 106137368

(51) Int. Cl. G06F 9/445; G06F 8/65; G06F 9/455

(52) U.S. Cl. CPC G06F 9/44521; G06F 9/45529; G06F 8/65

(57) ABSTRACT

This invention applied in the field of the library function hook/replacement of an Android virtual machine discloses an Android dynamic framework and a method thereof. Firstly, the Android dynamic framework of the present invention starts the APP Launch process and checks the version; if the version needs patching, the Android dynamic framework would download the Hook Files including the Hook Apk and the DF_File; then, the Android dynamic framework would check if a hook is the Native Hook or not, if it is the Native Hook, the Android dynamic framework would compile the Hook Apk, and, if it is not the Native Hook, the Android dynamic framework updates the Hook Share Library; and finally, the Android dynamic framework restarts the APP.

### CROSS-REFERENCE TO RELATED APPLICATION

This application claims the priority of Taiwanese patent application No. 106137368, filed on Oct. 30, 2017, which is incorporated herewith by reference.

### BACKGROUND OF THE INVENTION

### 1. Field of the Invention

The present invention relates to an Android system and a method thereof, and more particularly, to an Android dynamic framework and a method thereof applied in the field of the library function hook/replacement in the Android virtual machine. By modifying the related class loading mechanism and path of the Android virtual machine, the App user does not need to get the highest ROOT authority, and the Android dynamic framework can replace the native library function without installing any additional application and introduce an Android dynamic framework method hooking mechanism based on Android virtual machine to hook/replace the native library function without modifying any Apk file and affecting system stability and performance

### 2. The Prior Arts

Android provides an abundant application framework for programmer to develop many useful apps and interesting games in mobile devices. With the popularity of smartphones, more and more smartphone manufacturers adopt Android operation system. These vendors may develop their own SDK or system apps to promote user experiences. Building these programs also used the Android framework. With updating the Android version, the behavior of APIs in framework may change. That may affect these software products and there are some porting efforts for developer. The developer needs to modify their programs and reinstall them over-the-air updates their system. Therefore, the user needs a more convenient modification framework for programmers.

Mobile devices like smartphones and tablets are necessary to modern people. Android is an open source mobile operating system based on linux kernel and is mainly supported by Google. Being an open operating system, Android is used on many kinds of mobile devices. It results in a serious problem named “fragmentation”. Android Fragmentation means that there are many versions of Android platform and diverse hardware. It usually cause some problems about interoperability in Android ecosystem. It is painful for app developers and smartphone manufacturers. Each smartphone vendor may customize its own services and applications such as MIUI, HTC Sense to make their products different from the others. When Android updates its framework API, it may affect those software products and the venders must assign lots of programmers to port application from the old API to the new one. How to relieve the porting effort is a problem for the Android app developers.

Announced by Google, ART is a new runtime on Android. It was introduced as a new feature in KitKat version and was believed to supercede Dalvik in Android 5.0 Lollipop completely. ART made use of ahead-of-time (AOT) compilation. It differs from just-in-time(JIT) compiler in Dalvik is that it have an application to compile from bytecode to native code only once in installation time. Nevertheless, AOT compilation takes up storage space and may slightly extend time when installing application. Moreover, ART improved garbage collection mechanism and memory allocation, added new debugging feature of applications.

Xposed is a platform that allows user to modify the system behavior of their devices via installing custom modules. Similarly, vendors can use it to relax their problem. Xposed changes the system behavior through replacing methods. It is easy to use because of the integral APIs provided for programmers. However, the cost of a method call becomes huge after replacing an original method with a new one. And it doesn't support 64-bit devices currently. Moreover, if the users use Xposed, the users must turn off SELinux mode due to its internal implementation.

Meanwhile, Xposed is a framework that can change the behavior of android system and apps without modifying any source of APKs through installing modules. And the modules can work for different versions and even ROMs without any changes (as long as the original code was not changed too much). The Xposed extended APP process to modify some behaviors of runtime for preloading its modules, “XposedBridge” and “XposedHelper”, which utilize massive Java reflection mechanism. It provides an app, named “XposedInstaller”, to manage various modules for user, but users must “ROOT” their devices to access system-level permissions for the app. The Xposed for Android 5.0 has been released in February 2015 and currently don't support 64-bit devices not yet.

In other words, Xposed can achieve the goal of changing the behavior of android system or APP by installing modules. However, for Xposed, the cost of method invocation is huge after replacing an original method with a new method.

Dexposed is a powerful yet non-invasive runtime AOP (Aspect-oriented Programming) framework for Android app development, based on the work of open-source Xposed framework project. The AOP of Dexposed is implemented purely non-invasive, without any annotation processor, weaver or bytecode rewriter. The integration is loading a small JNI library in just one line of code at the initialization phase of the app. Not only the code of the app, but also the code of Android framework that running in the app process can be hooked. This feature is extremely useful in Android development as the developers heavily rely on the fragmented old versions of Android platform (SDK). Together with dynamic class loading, a small piece of compiled Java AOP code can be loaded into the running app, effectively altering the behavior of the target app without restart.

### SUMMARY OF THE INVENTION

Therefore, the main purpose of the present invention is to provide an Android dynamic framework and a method thereof. Firstly, the Android dynamic framework of the present invention starts the APP Launch process and checks the version; if the version needs patching, the Android dynamic framework would download the Hook Files including the Hook Apk and the DF_File; then, the Android dynamic framework would check that if a hook is the Native Hook or not, if it is the Native Hook, the Android dynamic framework would compile the Hook Apk, and, if it is not the Native Hook, the Android dynamic framework updates the Hook Share Library; and, finally, the Android dynamic framework restarts the APP.

One purpose of the present invention is to provide an Android dynamic framework and a method thereof to provides a framework that can dynamically change the behavior of Android system without modifying any APKs, a simple way for changing system and apps' method behavior dynamically, a solution with minimize changes to Android framework to make the system modification independent and modulized, and a way to call back original method to implement before-hook and after-hook like feature.

In other words, the Android dynamic framework provides a more efficient way to replace methods, solves the problem of the cost of a method call becoming huge after replacing an original method with a new one, and the problem of turning off SELinux mode due to the internal implementation in Xposed, and provides a much better performance than Xposed or Dexposed.

One purpose of the present invention is to provide an Android dynamic framework and a method thereof, wherein the Android dynamic framework is a framework that can dynamically change the behavior of Android system without modifying any APKs via replacing old method in system with new method in external .apk file, wherein in the Android dynamic framework, the programmers can finish modifying the system or app easily with putting DF_File and user-defined .apk file into system and then reboot. In other words, the Android dynamic framework provides a more convenient modification framework for the programmers, relieves the porting effort with describing simple DF File.

Another purpose of the present invention is to provide an Android dynamic framework and a method thereof to change methods dynamically, wherein the Android dynamic framework hooks the original method at linking time instead of compilation time so that the original part does not need to re-compile, and hence, reduce some unnecessary compilation time; wherein by using table-based mapping, the Android dynamic framework maintains a replaced table in ART VM to manage method replacement, and every entry of replaced table records the mapping of original method and replaced method; wherein by minimizing changes to the Android framework, typically, after modifying the Android framework, someone has to flash system ROM again, and, however, the Android dynamic framework uses dynamically replacing old method with new method to avoid flashing to minimize changes to the Androidh framework; wherein the Android dynamic framework makes the system modification independent and modularized to provide programmers a better development experience, to reduce some porting efforts and bug-fix time, and to develop the vendor's own SDK; and, wherein the Android dynamic framework provides a more superior performance than Xposed, and, after replacing original method with new method, the Android dynamic framework has more than 20 times speedup than Xposed in comparing the cost of method call.

In the Android system, the Android framework is not a specific layer of the Android architecture. Although some people may consider that it includes the Android Runtime, system services and some daemon process, however, in the present invention, the Android framework stands for the standard interface libraries that provide developers for developing their applications on the Android Platform. It is easy to reuse each component in framework for applications. The Android framework is implemented in Java, so it calls the system libraries via JNI (Java Native Interface), such as libc, WebKit.

In order to achieve the above said purposes, the present invention provides an Android dynamic framework. The Android dynamic framework comprises a mechanism, and a replace table.

When the application app is started and launched, the Google virtual machine ART is processing the application app launching system flow to completely load all classes and methods, and to proceed the link code. Each ArtMethod object has an entrypoint, the entrypoint determines how to execute the library function, and the work of the link code is to determine the entrypoint of the each ArtMethod object. If the library function is installed with the native machine code produced by the AOT, the ART would connect the ArtMethod entrypoint and the OatMethod, corresponding to the library function, and the OatMethod saves the machine code situation. And when the ArtMethod is executed, the library function would automatically jump to the pre-produced machine code. However, not all the library functions would proceed the AOT to produce the native machine code, and, therefore, for parts of un-compiled library functions, the ArtMethod entrypoint is set up to be the DEX code of the library functions in the DEXFile. And when the ArtMethod is executed, the library functions would jump to the DEX code and is executed by the interpreter.

A mechanism: after loading all the classes and methods, the mechanism would directly modify the Google ART virtual machine to replace the native library function(s). Firstly, the mechanism defines the method needed to be replaced, those information for the replacement is defined in the file named “DF_File”, the content in DF_File format explicitly defines locations of the class name, the library function name and the library signature of the replacement library function which replaces the original library function (i.e. the original method), and provides an APK file, named Hook Apk, including Hook method.

The mechanism does a series of work in different stages when launching the application app and booting the android system. The different stages are listed below:
1. Push Custom .dex file and DF_File in ROM.
2. Load the Hook Apk.
3. Load the app Apk and determine which library function needed to be replaced.

The mechanism will use the .dex file and the DF_File at different stages during boot time, and parses DF_File and uses the output to initialize the replace table before starting the zygote. The mechanism push these .dex file and DF_File into ROM and then into a replace table having specific data structure for particularly recording and indicating which library function is needed to be replaced by what library function, and then reboot the system. Dynamic Framework parses the DF_File and then uses the output to initialize the replace table before starting the zygote. The replace table stores all replacement information.

A replace table: after initializing the replace table, the mechanism would load the Hook Apk. If it is the first time to load the Hook Apk, the system would compile it, and, meanwhile, ROM of the system keeps the all Artmethod objects of all the classes of the Hook Apk. After that, the mechanism loads the App class. The ClassLinker would push the classes of the Apk one by one in ROM with corresponding data structure.

When the mechanism loads the ArtMethod, it is the time to intercept the ArtMethod. Before loading the library function and pushing the ArtMethod, the mechanism would look up information of the replace table, and check that the library function is needed to be replaced or not. If the answer is not, the loading process is as usual, but if the answer is yes, the mechanism would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

In the process of the Android dynamic framework executing the Android dynamic framework method, the first step is to start the APP Launch process and checks the version.

Then, if the version needs patching, the Android dynamic framework would download the Hook Files including the Hook Apk and the DF_File.

The mechanism defines the method needed to be replace, those information for the replacement is defined in the file named “DF_File”, the content in DF_File format explicitly defines locations of the class name, the library function name and the library signature of the replacement library function which replaces the original library function (i.e. the original method), and provides an APK file, named Hook Apk, including Hook method; and, the mechanism push these .dex file and DF_File into ROM and then into a replace table having specific data structure for particularly recording and indicating which library function (i.e. at least one first library function) is needed to be replaced by a library function (i.e. at least one second library function), and after initializing the replace table, the mechanism would load the Hook Apk.

In the next step, after initializing the replace table and loading the Hook Apk, the mechanism would check that if it is the Native Hook or not, if it is the Native Hook, the mechanism would compile the Hook Apk, and, if it is not the Native Hook, the mechanism updates the Hook Share Library; and, that is, after initializing the replace table and loading the Hook Apk, if it is the first time to load the Hook Apk, the mechanism would compile it, however, if it is not the first time to load the Hook Apk, the mechanism would update the Hook Share Library, and in the meantime, the ROM keeps all the ArtMethod objects of all the classes in the Hook Apk.

In this step, the mechanism starts loading the app class. The ClassLinker would push the classes of the Apk one by one in ROM with corresponding data structure.

When the mechanism loads the ArtMethod, it is the time to intercept the ArtMethod. Before loading the library function and pushing the ArtMethod, the mechanism would look up the information of the replace table, and check that the library function is needed to be replaced or not. If the answer is not, the loading process is as usual, but if the answer is yes, the mechanism would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

Finally, the Android dynamic framework restarts the application app.

The foregoing will become better understood from a careful reading of a detailed description provided herein below with appropriate reference to the accompanying drawings.

### BRIEF DESCRIPTION OF THE DRAWINGS

The embodiments can be understood in more detail by reading the subsequent detailed description in conjunction with the examples and references made to the accompanying drawings, wherein:

FIG. 1 is a system schematic view illustrating the system architecture and operation of the Android dynamic framework according to the present application;

FIG. 2 is a flowchart of the Android dynamic framework method utilizing the Android dynamic framework in FIG. 1;

FIG. 3 is a schematic view illustrating an embodiment and an operation of the embodiment of the Android dynamic framework according to the present invention;

FIG. 4 is a schematic view illustrating the DF_File Format according to FIG. 3;

FIG. 5 is a schematic view illustrating a method to process methods according to the embodiment in FIG. 3;

FIG. 6 is a schematic view illustrating another method to process methods according to the embodiment in FIG. 3; and

FIG. 7 is a flowchart of the Android dynamic framework method utilizing the embodiment of the Android dynamic framework according to FIG. 3.

### DETAILED DESCRIPTION OF THE PREFERRED EMBODIMENT

In the following detailed description, for purpose of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

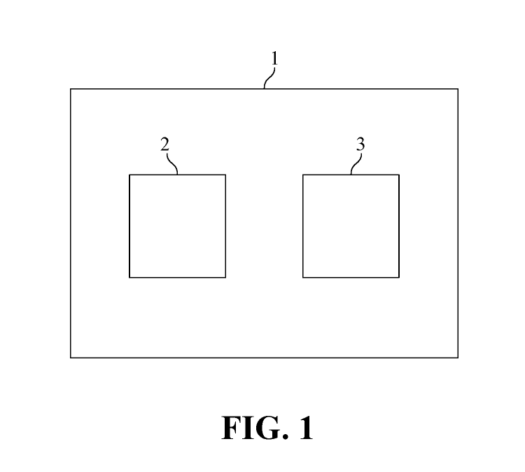

FIG. 1 is a system schematic view illustrating the system architecture and operation of the Android dynamic framework according to the present application.

As shown in FIG. 1, the Android dynamic framework 1 comprises a mechanism 2, and a replace table 3.

When the application app is started and launched, the Google virtual machine ART is processing the application app launching system flow to completely load all classes and methods, and to proceed the link code. Each ArtMethod object has an entrypoint, the entrypoint determines how to execute the library function, and the work of the link code is to determine the entrypoint of the each ArtMethod object. If the library function is installed with the native machine code produced by the AOT, the ART would connect the ArtMethod entrypoint and the OatMethod, corresponding to the library function, and the OatMethod saves the machine code situation. And when the ArtMethod is executed, the library function would automatically jump to the pre-produced machine code. However, not all the library functions would proceed the AOT to produce the native machine code, and, therefore, for parts of un-compiled library functions, the ArtMethod entrypoint is set up to be the DEX code of the library functions in the DEXFile. And when the ArtMethod is executed, the library functions would jump to the DEX code and is executed by the interpreter.

After loading all the classes and methods, the mechanism 2 would directly modify the Google ART virtual machine to replace the native library functions. Firstly, the mechanism 2 defines the method needed to be replaced, those information for the replacement is defined in the file named “DF_File”, the content in DF_File format explicitly defines locations of the class name, the library function name and the library signature of the replacement library function which replaces the original library function (i.e. the original method), and provides an APK file, named Hook Apk, including Hook method.

The mechanism 2 does a series of work in different stages when launching the application app and booting the android system. The different stages are listed below:
1. Push Custom .dex file and DF_File in ROM.
2. Load the Hook Apk.
3. Load the app Apk and determine which library function needed to be replaced.

The mechanism 2 will use the .dex file and the DF_File at different stages during boot time, and parses DF_File and uses the output to initialize the replace table 3 before starting the zygote. The mechanism 2 push these .dex file and DF_File into ROM and then into the replace table 3 having specific data structure for particularly recording and indicating which library function is needed to be replaced by what library function, and then reboot the system. The mechanism 2 parses the DF_File and then uses the output to initialize the replace table 3 before starting the zygote. The replace table 3 stores all replacement information.

After initializing the replace table 3, the mechanism 2 would load the Hook Apk. If it is the first time to load the Hook Apk, the mechanism 2 would compile it, and, meanwhile, ROM of the system keeps the all Artmethod objects of all the classes of the Hook Apk. After that, the mechanism 2 loads the app class. The ClassLinker would push the classes of the Apk one by one in ROM with corresponding data structure.

When the mechanism 2 loads the ArtMethod, it is the time to intercept the ArtMethod. Before loading the library function and pushing the ArtMethod, the mechanism 2 would look up the information of the replace table 3, and check that the library function is needed to be replaced or not. If the answer is not, the loading process is as usual, but if the answer is yes, the mechanism 2 would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

As for the replacement table 3, the mechanism 2 push these .dex file and DF_File into ROM and then into the replace table 3 having specific data structure for particularly recording and indicating which library function (i.e. at least one first library function) is needed to be replaced by a library function (i.e. at least one second library function), and therefore, the replace table 3 stores all replacement information.

The mechanism 2 parses the DF_File and then uses the output to initialize the replace table 3 before starting the zygote. The replace table 3 stores all replacement information.

After initializing the replace table 3, the mechanism 2 would load the Hook Apk. If it is the first time to load the Hook Apk, the mechanism 2 would compile it, meanwhile, ROM of the system keeps the all ArtMethod objects of all the classes of the Hook Apk.

Accordingly, after that, the mechanism 2 loads the app class. The ClassLinker would push the classes of the Apk one by one in ROM with corresponding data structure. When the mechanism 2 loads the ArtMethod, it is the time to intercept the ArtMethod. Before loading the library function and pushing the ArtMethod, the mechanism 2 would look up the information of the replace table 3, and check that the library function is needed to be replaced or not. If the answer is not, the loading process is as usual, but if the answer is yes, the mechanism 2 would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

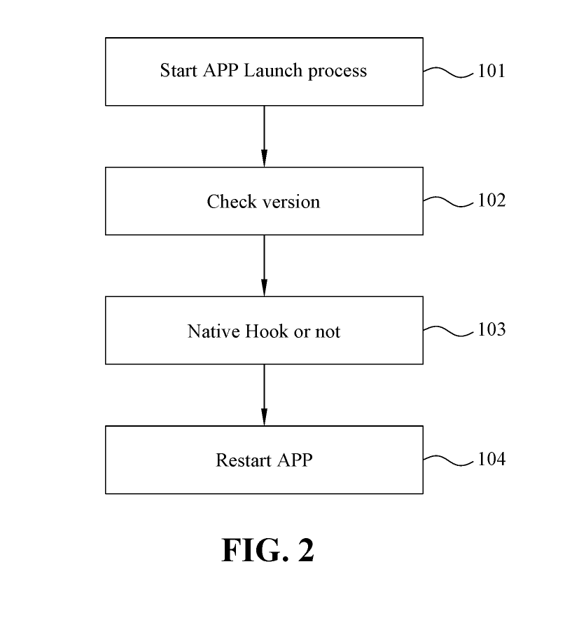

FIG. 2 is a flowchart of the Android dynamic framework method utilizing the Android dynamic framework in FIG. 1.

As shown in FIG. 2, step 101 is to start the APP Launch process and to check the version. The operation then proceeds to step 102.

Step 102 is to check the version; wherein if the version needs patching, the Android dynamic framework would download the Hook Files including the Hook Apk and the DF_File. The operation then proceeds to step 103.

In the step 102, the mechanism 2 defines the methods needed to be replaced, those information for the replacement is defined in the file named “DF_File”, the content in DF_File format explicitly defines locations of the class name, the library function name and the library signature of the replacement library function which replaces the original library function (i.e. the original method), and provides an APK file, named Hook Apk, including Hook method; and, the mechanism 2 parses the DF_File and then uses the output to initialize the replace table 3 before starting the zygote, the replace table 3 stores all replacement information, and after initializing the replace table 3, the mechanism 2 would load the Hook Apk.

Step 103 is to check that it is the Native Hook or not; wherein after initializing the replace table and loading the Hook Apk, the mechanism 2 would check that if it is the Native Hook or not, if it is the Native Hook, the mechanism 2 would compile the Hook Apk, and, if it is not the Native Hook, the mechanism 2 updates the Hook Share Library; and, that is, after initializing the replace table 3 and loading the Hook Apk, if it is the first time to load the Hook Apk, the mechanism 2 would compile it, however, if it is not the first to load the Hook Apk, the mechanism 2 would update the Hook Share Library, and in the meantime, the ROM keeps all the ArtMethod objects of all the classes in the Hook Apk. The operation then proceeds to step 104.

In the step 103, the mechanism 2 starts loading the app class. The ClassLinker would push the classes of the Apk one by one in ROM with corresponding data structure.

When the mechanism 2 loads the ArtMethod, it is the time to intercept the ArtMethod. Before loading the library function and pushing the ArtMethod, the mechanism 2 would look up the information of the replace table 3, and check that the library function is needed to be replaced or not. If the answer is not, the loading process is as usual, but if the answer is yes, the mechanism 2 would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

Step 104 is to restart the application app.

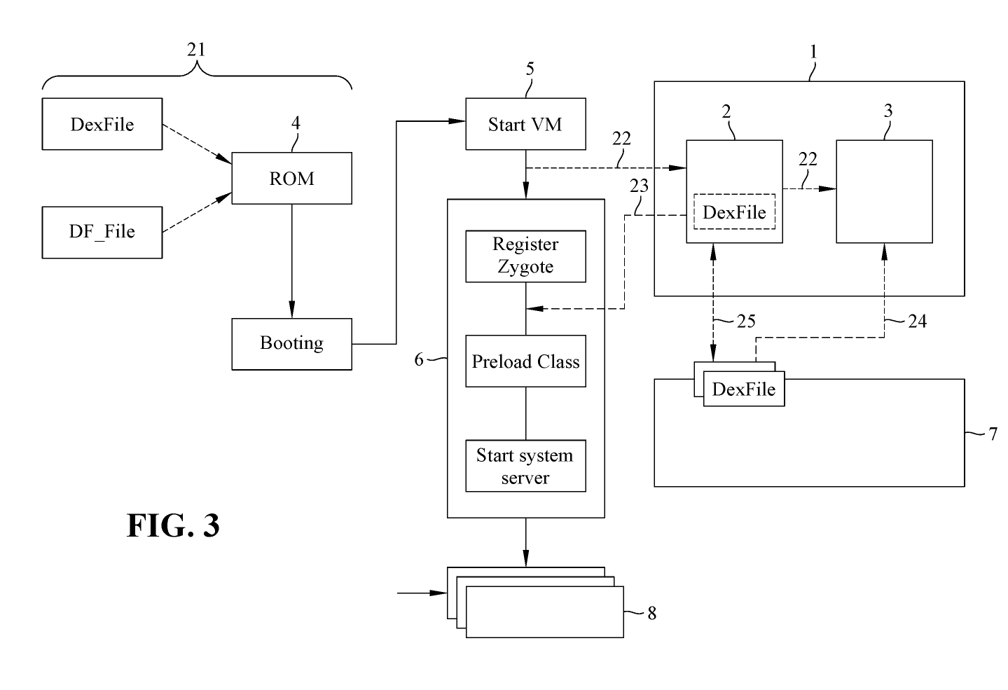

FIG. 3 is a schematic view illustrating an embodiment and an operation of the embodiment of the Android dynamic framework according to the present invention.

FIG. 3 shows the system flow of the embodiment of the Android dynamic framework 1 when booting the Android system. The Android dynamic framework 1 does a series of work in different stages.

As shown in FIG. 3, in flow 21, the mechanism 2 pushes custom .dex file and DF_File in ROM 4; wherein the mechanism 2 pushes these two items into ROM and then reboot the android VM (virtual machine) 5, and the mechanism 2 will use the .dex file and the DF_File them at different stages during boot time. The operation then proceeds to flow 22.

In flow 22, the mechanism 2 initializes the replace table 3; wherein the mechanism 2 parses the DF_File and then uses the output to initialize the replace table 3 before starting the zygote 6, and the replace table 3 stores all replacement information. The operation then proceeds to flow 23.

Zygote 6 is a daemon service whose main job is to launch app process. The startup of the process is invoked by init.rc but it is actually started by the app process. The main work in Zygote 6 is to start System Server and create a socket to listening for starting application. To enhance app launch time, the Zygote 6 preloads all necessary Java classes and resources that are commonly used in runtime. The System Server is the first process started by the Zygote 6. After setting it up, the Zygote 6 starts to listen commands on a socket to launch application. Since android is based on linux, it uses the copy-on-write policy to fork process.

In flow 23, the mechanism 2 compiles custom .dex file and preload classes in it; wherein at starting zygote 6 stage, the mechanism 2 compiles the custom .dex files in ROM and then preload its classes in memory. The operation then proceeds to flow 24.

In flow 24, the mechanism 2 looks up the replace table 3 when loading class; wherein when zygote 6 preloads classes or launches apps, it loads these necessary classes object via class linker; and, when loading class, the class linker looks up the replace table 3 to verify whether methods in the class are replacement candidates or not. The operation then proceeds to flow 25.

In flow 25, the mechanism 2 replaces candidate methods in the framework 7; wherein, once the class linker finds the method is a replacement candidate, it replaces the method with the corresponding new method.

When the application app is started and launched, the Google virtual machine ART is processing the application app launching system flow to completely load all classes and methods, and to proceed the link code. Each ArtMethod object has an entrypoint, the entrypoint determines how to execute the library function, and the work of the link code is to determine the entrypoint of the each ArtMethod object. If the library function is installed with the native machine code produced by the AOT, the ART would connect the ArtMethod entrypoint and the OatMethod, corresponding to the library function, and the OatMethod saves the machine code situation. And when the ArtMethod is executed, the library function would automatically jump to the pre-produced machine code. However, not all the library functions would proceed the AOT to produce the native machine code, and, therefore, for parts of un-compiled library functions, the ArtMethod entrypoint is set up to be the DEX code of the library functions in the DEXFile. And when the ArtMethod is executed, the library functions would jump to the DEX code and is executed by the interpreter.

After loading all the classes and methods, the mechanism 2 would directly modify the Google ART virtual machine to replace the native library functions. Firstly, the mechanism 2 defines the method needed to be replace, those information for the replacement is defined in the file named “DF_File”, the content in DF_File format explicitly defines locations of the class name, the library function name and the library signature of the replacement library function which replaces the original library function (i.e. the original method), and provides an APK file, named Hook Apk, including Hook method.

The mechanism 2 does a series of work in different stages when launching the application app and booting the android system. The different stages are listed below:
1. Push Custom .dex file and DF_File in ROM.
2. Load the Hook Apk.
3. Load the App Apk and determine which library function needed to be replaced.

The mechanism 2 will use the .dex file and the DF_File at different stages during boot time, and parses DF_File and uses the output to initialize the replace table 3 before starting the zygote. The mechanism 2 push these .dex file and DF_File into ROM and then into the replace table 3 having specific data structure for particularly recording and indicating which library function (i.e. at least one first library function) is needed to be replaced by a library function (i.e. at least one second library function), and then reboot the system. The mechanism 2 parses the DF_File and then uses the output to initialize the replace table 3 before starting the zygote. The replace table 3 stores all replacement information.

After initializing the replace table 3, the mechanism 2 would load the Hook Apk. If the Hook Apk is firstly loaded, the mechanism 2 would compile it, and, meanwhile, ROM of the system keeps the all Artmethod objects of all the classes of the Hook Apk. After that, the mechanism 2 loads the app class. The ClassLinker would push the classes of the Apk one by one in ROM with corresponding data structure.

When the mechanism 2 loads the ArtMethod, it is the time to intercept the ArtMethod. Before loading the library function and pushing the ArtMethod, the mechanism 2 would look up the information of the replace table 3, and check that the library function is needed to be replaced or not. If the answer is not, the loading process is as usual, but if the answer is yes, the mechanism 2 would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

The mechanism 2 pushes these .dex file and DF_File into ROM and then into the replace table 3 having specific data structure for particularly recording and indicating which library function is needed to be replaced by what library function, and therefore, the replace table 3 stores all replacement information.

The mechanism 2 parses the DF_File and then uses the output to initialize the replace table 3 before starting the zygote. The replace table 3 stores all replacement information.

After initializing the replace table 3, the mechanism 2 would load the Hook Apk. If it is the first time to load the Hook Apk, the mechanism 2 would compile it, meanwhile, ROM of the system keeps the all ArtMethod objects of all the classes of the Hook Apk.

Accordingly, after that, the mechanism 2 loads the app class. The ClassLinker would push the classes of the Apk one by one in ROM with corresponding data structure. When the mechanism 2 loads the ArtMethod, it is the time to intercept the ArtMethod. Before loading the library function and pushing the ArtMethod, the mechanism 2 would look up information of the replace table 3, and check that the library function is needed to be replaced or not. If the answer is not, the loading process is as usual, but if the answer is yes, the mechanism 2 would take out the ArtMethod object of the candidate replacement library function from the pre-loaded Hook class, and copy the whole ArtMethod object into the ArtMethod object of the original method which is originally loaded by the application app. Therefore, later in the application app execution, the jumped ArtMethod object is the library function needed to be replaced.

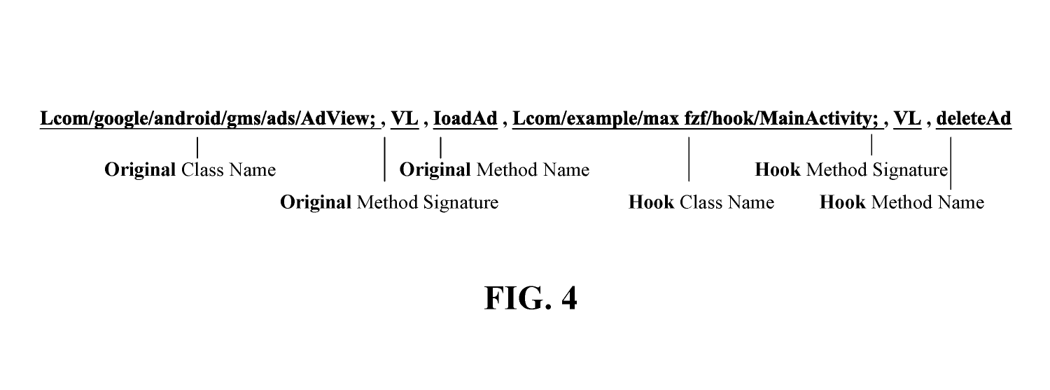

FIG. 4 is a schematic view illustrating the DF_File Format according to FIG. 3.

The DF_File is used to describe the mapping in detail between original method and new method. The DF_File uses to initialize the replaced table 3 at booting time in the android dynamic framework 1. In the DF_File, every entry stands for an method replacement operation. If the mapping is incorrect, the replacement will not occur. That does not make system crash. In every entry, description of Original method is put on the left-hand side, while the right-hand side is description of hook method.

Method Description contains three parts: name of class, wherein it must use the fully qualified name of a class in class name field; method signature, wherein a signature is part of the method description, and it is the combination of the return type and the parameter list; and name of method indicating which method has to replace or to be replaced.

FIG. 4 shows Original class Name path, Original Method Signature, Original Method Name, Hook Class Name, Hook Method Signature, and Hook Method Name.

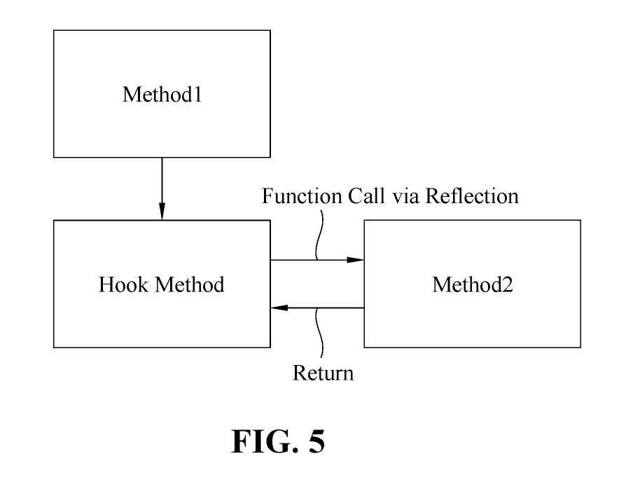

FIG. 5 is a schematic view illustrating a method to process methods according to the embodiment in FIG. 3.

As shown in FIG. 5, the method 1 and the method 2 are before-hook method and after-hook method (Before/After Hook methods), wherein the Android dynamic framework 1 does the AdBlocker job.

The advertisements of the Android app are mostly from the third part API, therefore, the Android dynamic framework 1 can analyze the third party API, replace the specific onCreate library function of the application app to make the app un-set up. After replacing the library function, the mechanism 2 can utilize Java reflection to get the original library function and call it for intercepting the method related to display the advertisements, and for easily blocking the advertisements.

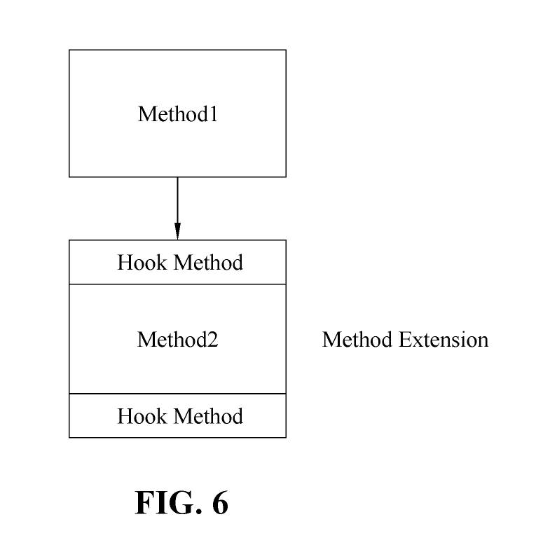

FIG. 6 is a schematic view illustrating another method to process methods according to the embodiment in FIG. 3.

As shown in FIG. 6, the method 1 and the method 2 are before-hook method and after-hook method (Before/After Hook methods), wherein the Android dynamic framework 1 does the Method Extension job.

As shown in FIG. 6, after replacing the library function, the mechanism 2 can utilize Java reflection to get the original library function and call it. The mechanism 2 does many jobs in the original library function (method 1), and extends the method 1 to be the method 2 with the Hook method in both sides for achieving the Method Extension effect. By using this way, the mechanism 2 can do many applications.

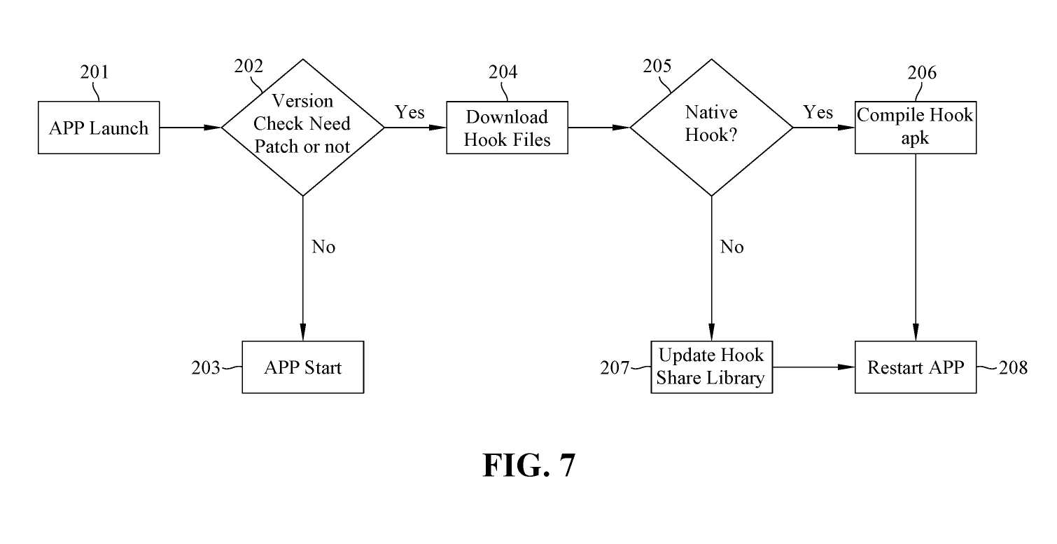

FIG. 7 is a flowchart of the Android dynamic framework method utilizing the embodiment of the Android dynamic framework according to FIG. 3.

As shown in FIG. 7, step 201 is to start the APP Launch process and checks the version. The operation then proceeds to step 202.

Step 202 is to check the version; wherein if the version does not need patching, the operation then proceeds to step 203; and wherein if the version needs patching, the operation then proceeds to step 204.

In step 203, the mechanism 2 starts the app launch process.

In step 204, the mechanism 2 would download the Hook Files including the Hook Apk and the DF_File. The operation then proceeds to step 205.

In the step 204, the mechanism 2 defines the methods needed to be replaced, those information for the replacement is defined in the file named “DF_File”, the content in DF_File format explicitly defines locations of the class name, the library function name and the library signature of the replacement library function which replaces the original library function (i.e. the original method), and provides an APK file, named Hook Apk, including Hook method; and, the mechanism 2 parses the DF_File and then uses the output to initialize the replace table 3 before starting the zygote, the replace table 3 stores all replacement information, and after initializing the replace table 3, the mechanism 2 would load the Hook Apk.

Step 205 is to check that if it is the Native Hook or not; wherein after initializing the replace table 3 and loading the Hook Apk, the mechanism 2 would check that if it is the Native Hook or not; wherein if it is the Native Hook, the operation then proceeds to step 206; and, wherein if it is not the Native Hook, the operation then proceeds to step 207.

In step 206, the mechanism 2 compiles the Hook Apk. The operation then proceeds to step 208.

In step 207, the mechanism 2 updates the Hook Share Library. The operation then proceeds to step 208.

That is, in steps 205, 206 and 207, after initializing the replace table 3, the mechanism 2 would load the Hook Apk, if it is the first time to load the Hook Apk, the mechanism 2 would compile it, however, if it is not the first to load the Hook Apk, the mechanism 2 would update the Hook Share Library, and in the meantime, the ROM keeps all the ArtMethod objects of all the classes in the Hook Apk.

In steps 205, 206 and 207, the mechanism 2 starts loading the app class; wherein the ClassLinker would push the classes of the Apk one by one in ROM with corresponding data structure; wherein when the mechanism 2 loads the ArtMethod, it is the time to intercept the ArtMethod; wherein before loading the library function and pushing the ArtMethod, the mechanism 2 would look up the information of the replace table 3, and check that the library function is needed to be replaced or not; wherein if the answer is not, the loading process is as usual, but if the answer is yes, the mechanism 2 would take out the ArtMethod object of the candidate replacement library function from the pre-loaded Hook class, and copy the whole ArtMethod object into the ArtMethod object of the original method which is originally loaded by the application app; and, wherein, later in the application app execution, the jumped ArtMethod object is the library function needed to be replaced.

In step 208, the android dynamic framework 1 restarts the APP.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An Android dynamic framework method applied in the field of the library function hook/replacement of an Android virtual machine, comprising the steps of:
starting an App Launch process and checking an version of the App;
downloading Hook Files including Hook Apk and DF_File, wherein the version needs patching;
determining whether a hook is a Native Hook or not; while the hook is the Native Hook, compiling the Hook Apk, and while the hook is not the Native Hook, updating the Hook share Library; and
restarting the App.

2. The Android dynamic framework method as claimed in claim 1, wherein the DF_File comprises information of at least one first library function needed to be replaced, and information of at least one second library function to replace the at least one first library function.

3. The Android dynamic framework method as claimed in claim 2, wherein an content in the DF_File format defines locations of class name, library function name and library signature of the at least one second library function, and provides an APK file, named Hook Apk, including Hook method.

4. The Android dynamic framework method as claimed in claim 3, wherein the DF_File is pushed into ROM and a replace table, for recording the information of the at least one first library function and the information of the at least one second library function, and after initializing the replace table, the Hook Apk is loaded.

5. An Android dynamic framework applied in the field of the library function hook/replacement of an Android virtual machine, comprising:
a replace table; and
a mechanism,
wherein the mechanism starts an App Launch process and checks an version of the App, downloads Hook Files including Hook Apk and DF_File,
wherein when the version needs patching, the mechanism determines whether a hook is a Native Hook or not, while the hook is the Native Hook, the mechanism compiles the Hook Apk, and while the hook is not the Native Hook, the mechanism updates the Hook share Library; and
wherein the mechanism restarts the App.

6. The Android dynamic framework as claimed in claim 5, wherein the DF_File comprises information of at least one first library function needed to be replaced, and information of at least one second library function to replace the at least one first library function.

7. The Android dynamic framework as claimed in claim 6, wherein an content in the DF_File format defines locations of class name, library function name and library signature of the at least one second library function, and provides an APK file, named Hook Apk, including Hook method.

8. The Android dynamic framework as claimed in claim 7, wherein the DF_File is pushed into ROM and a replace table, for recording the information of the at least one first library function and the information of the at least one second library function, and after initializing the replace table, the Hook Apk is loaded.
